(19) United States
(12) Patent Application Publication
(10) Pub. No.: US 2011/0261087 A1
(43) Pub. Date: Oct. 27, 2011

(54) DISPLAY BRIGHTNESS CONTROL METHOD

(76) Inventor: Jae-Hyun Bahk, Gumi-Gyeongbuk (KR)

(21) Appl. No.: 12/992,396

(22) PCT Filed: May 12, 2009
(86) PCT No.: PCT/KR09/02497

§ 371 Date: Feb. 14, 2011

(30) Foreign Application Priority Data
May 13, 2008 (KR) 10-2008-0044201

(51) Int. Cl. G09G 5/10

(52) U.S. Cl. 345/690

(57) ABSTRACT

A display brightness control method includes the steps of comparing a display-setting value, which is input by user operation, with a setting value, which is set in advance to a display, if a changed setting value is present, reflecting the changed setting value to the display, determining whether or not the display-setting value is present, if the display-setting value is present, reflecting the changed display-setting value to the display, and after the changed display-setting value is reflected, standing by until a subsequent display-setting value is input. In addition, the screen output areas of the display divided into the used area and the unused area, so that the used area remains original and the unused area is controlled to have the minimized level of brightness or be powered off. It is possible to prevent the visibility from being lowered by the display and protect the vision of the user.

### TECHNICAL FIELD

The present invention relates to a display brightness control method, and more particularly, to a display brightness control method, which controls operation by dividing screen output areas of a display into an used area and an unused area, so that the used area is output at the original level of brightness and the unused area is controlled to have the minimized level of brightness or the supply of electric power to the unused area is suspended.

### BACKGROUND ART

In general, a display functions as an interface between a mechanical device and a user so that the user can easily check processes occurring inside a terminal, such as a Personal Computer (PC), and the results of the processes.

Such a display originated with a Cathode Ray Tube (CRT), and has recently been developed in the form of a Liquid Crystal Display (LCD), a Plasma Display Panel (PDP), and the like, in order to realize low power consumption and optimize the use of space.

In the meantime, in response to the development of wired/wireless communication networks, the use of portable terminals, such as a mobile phone, a notebook computer, a Personal Digital Assistant (PDA), and the like, has become widespread. So, in order to increase the amount of time that the portable terminal is operated between charges, technologies for increasing the amount of time that the portable terminal can be operated on a battery, such as technology for increasing the capacity of the battery, are being developed.

One of these technologies is a method of controlling the brightness of the entire screen of a display in order to improve the efficiency of use of the battery for the display, which consumes a large amount of electric power.

However, this method of controlling the brightness has problems in that the entire screen of the display becomes gradually darker as the amount of power remaining in the battery decreases, and in that the vision of the user is lowered.

In addition, since the brightness of the entire screen is controlled, a large amount of battery power is consumed, and the lifetimes of the display and the battery are reduced.

Therefore, there are demands for technology, which divides the entire screen of the display into an area (used area), which is used by the user, and an area (unused area, such as a banner window), which is not used by the user, in order to control the brightness of the output screen of the corresponding area or control the size of the output screen so that only a portion of the entire screen of the display is used (e.g., an area of about 13 inches in a 15 inch display is used).

### TECHNICAL PROBLEM

The present invention has been made to solve the foregoing problems with the prior art, and therefore an object of the present invention is to provide a display brightness control method, which controls operation by dividing screen output areas of a display into an used area and an unused area, so that the used area is output at the original level of brightness and the unused area is controlled to have the minimized level of brightness or the supply of electric power to the unused area is suspended. Accordingly, a battery, which is used in a portable PC, a tablet PC, a mobile communication terminal, a PDA, and the like, consumes less power, the lifetime of the display is increased, and only a predetermined area of the display, which the user needs, is controlled to be bright.

### TECHNICAL SOLUTION

In an aspect of the present invention, the display brightness control method includes the following steps of: comparing a display-setting value, which is input by user operation, with a setting value, which is set in advance to a display; if a changed setting value is present, reflecting the changed setting value to the display; determining whether or not the display-setting value is present; if the display-setting value is present, reflecting the changed display-setting value to the display; and after the changed display-setting value is reflected, standing by until a subsequent display-setting value is input.

In an exemplary embodiment of the invention, the display-setting value may be a brightness-setting value of a light-source device according to the contrast and the bright of the display and the type of the display (an LCD, an OLED, a TFT LCD, a PDP, and the like), and a setting value, with which an area of the display is selected.

In an exemplary embodiment of the invention, a predetermined area on the display is selected, so that the selected area remains at the original brightness and the brightness of the other area and whether or not to supply electrical power to the other area is controlled at user request.

In an exemplary embodiment of the invention, an area of the display on which a program window is being displayed remains at the original brightness and the brightness of the other area and whether or not to supply electrical power to the other area is controlled at user request.

In an exemplary embodiment of the invention, whether or not to change a screen on the display is detected in response to the user operation, and the changed area remains at the original brightness and the brightness of the other area and whether or not to supply electrical power to the other area is controlled at user request.

In exemplary embodiments of the invention, the display brightness control method can control the screen of the display using application programs (including programs in use for an operating system) installed in a PC or a communication device, by controlling one or more (which are mutually organized with each other) selected among from an application program of the PC or the communication device, a system driver of a video card, firmware as internal S/W of the display, and the operating system for operating them are controlled, in which the application program and the firmware cooperate with each other (using communication means, such as 12C, BESA, or the like)

### ADVANTAGEOUS EFFECTS

The display brightness control method of the invention as set forth above has effects of reducing the power consumption of a battery, which is used in a portable PC, a tablet PC, a mobile communication terminal, a PDA, and the like, and increasing the lifetime of the display by controlling the brightness of a predetermined area of the display by dividing it from the other areas.

In addition, the screen output areas of the display divided into the used area and the unused area, so that the used area is output at the original level of brightness and the unused area is controlled to have the minimized level of brightness or be powered off. Therefore, it is possible to prevent the visibility from being lowered by the display and protect the vision of the user.

### DESCRIPTION OF DRAWINGS

FIG. 1 is a flowchart showing a display brightness control method according to an exemplary embodiment of the invention;

FIG. 2 is a flowchart showing a method of controlling different levels of brightness using a touch pointer according to another embodiment of the invention;

FIG. 3 is a flowchart showing a method of controlling different levels of brightness based on a change on the display according to another embodiment of the invention;

FIG. 4 is a screen showing an example of the result produced by controlling the display according to the invention; and

FIG. 5 is a screen showing another example of the result produced by controlling the display according to the invention.

### BEST MODE

A display brightness control method of the present invention will now be described more fully hereinafter with reference to the accompanying drawings, in which exemplary embodiments thereof are shown.

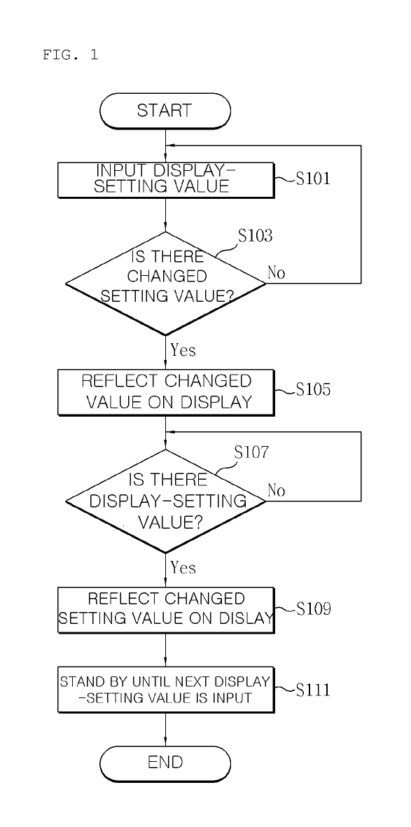

FIG. 1 is a flowchart showing a display brightness control method according to an exemplary embodiment of the invention.

Referring to FIG. 1, first, display-setting values are input by a user (S101).

The setting values include the contrast, brightness, and the like of a display, and also include, for example, respective power management information about apparatuses for supplying display light sources according to the type of the display. Here, the respective power management information is a piece of information that is used to control and manage a plurality of lamps (i.e., light-emitting elements) provided in a backlight unit of the display.

If an operating system is installed in a display, the brightness-setting value includes control information that can be used to control the brightness of a program window executed by the operating system.

In addition, if a mouse is used on the display, the brightness-setting value includes control information, which can be used to control the brightness, shape, and size, which are designated by the user, based on a pointer of the moving mouse.

In addition, the brightness-setting value includes time control information, which is used to maintain a predetermined area on the display at a predetermined level of brightness for a predetermined time. Based on the time control information as above, it is possible to use the display by maintaining the original brightness of the area of the program window that the user is using, or of a predetermined area around the mouse, while minimizing the brightness of the other areas.

Here, it is preferred that the setting value of the invention be input using one selected from among a keypad and a remote control of the display, and a piece of software installed in a Personal Computer (PC).

After the step S101, whether or not a changed setting value is present is determined (S103). If the changed setting value is present, the changed setting value is reflected on the display (S105).

After the step S105, whether or not the display-setting value is present is determined (S107). If the display-setting value is present, the changed display-setting value is reflected on the display (S109), and then operation stands by until a subsequent display-setting value is input (S111).

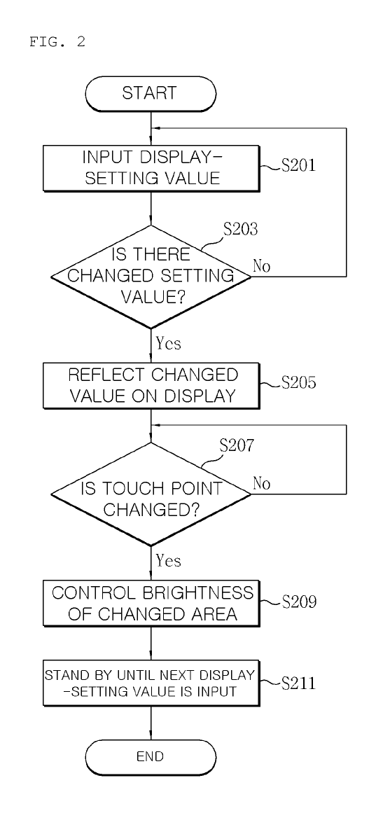

FIG. 2 is a flowchart showing a method of controlling different levels of brightness using a touch pointer according to another embodiment of the invention.

Referring to FIG. 2, first, a user inputs display-setting values (S201).

After the step S201, whether or not a changed setting value is present is determined (S203). If the changed setting value is present, the changed setting value is reflected on the display (S205).

After the step S205, whether or not a touch point has been changed by the operation of the user is determined (S207). If the touch point has been changed, the brightness of the changed area is controlled (S209), and operation stands by until a subsequent display-setting value is input (S211).

Through the process shown in FIG. 2, the operation is controlled along the track of the touch pointer on the display, so that the shape designated by the user or the area having the size designated by the user remains at the original brightness while the other areas become dark.

In the case in which the brightness of the display or the like of a mobile communication terminal is controlled, even if no mouse pointer is present on the mobile communication terminal, the operation can be controlled using a touch pointer (an area or point on the screen with which a hand or a pen is brought into contact) on a touch screen of the mobile communication terminal along the track of the touch pointer on the display, so that the shape designated by the user or the shape having the size designated by the user remains at the original brightness while the other areas become dark.

In addition, in this embodiment, the user can be allowed to designate the time, in which the original brightness is maintained. Thus, the operation can be controlled via one touch, so that the area surrounding the touch pointer remains at the original brightness for a predetermined time and the other areas become dark.

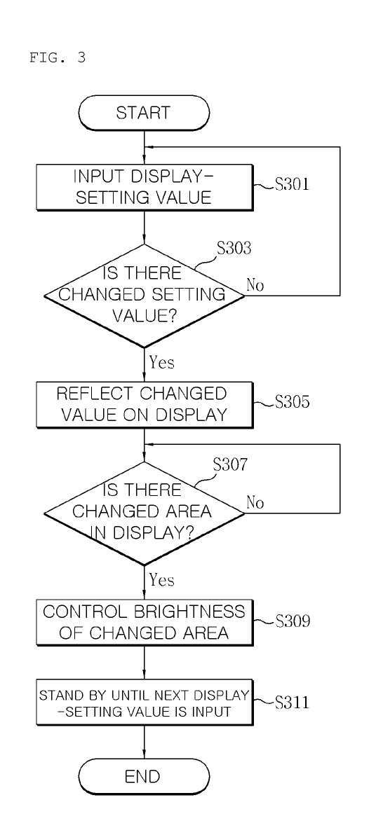

FIG. 3 is a flowchart showing a method of controlling different levels of brightness based on a change on the display according to another embodiment of the invention;

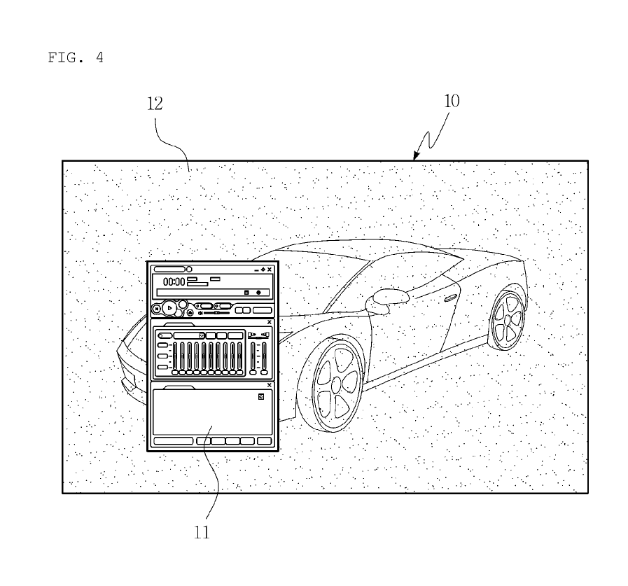

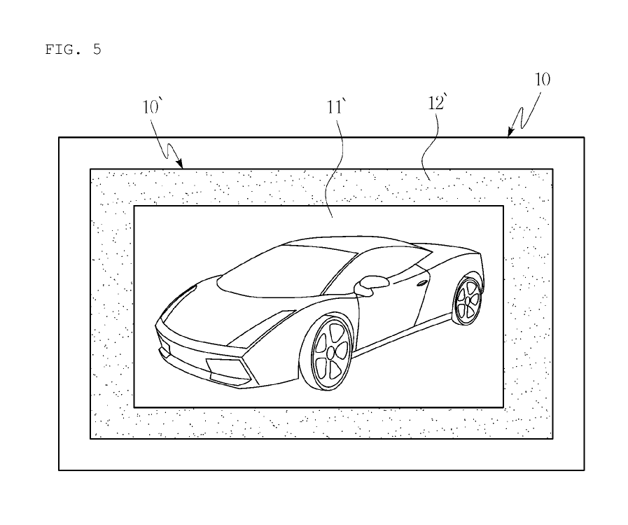

Referring to FIG. 3, the user inputs a display-setting value in the same fashion as in FIGS. 1 and 2 (S301). Here, the display-setting value includes at least one selected from among a brightness-setting value, a minimum value of each area, and an area-setting value of the display, the brightness-setting value including at least one selected from among setting values about contrast, brightness, and brightness of each area of the display. As shown in FIGS. 4 and 5, the user can input the setting values of each area and brightness, and the values can be automatically set by the request from a person having ordinary skill in the art.

After the step S301, whether or not a changed setting value is present is determined (S303). If the changed setting value is present, the changed setting value is reflected on the display (S305).

After the step S305, whether or not an area on the display (the screen) has been changed is determined (S307). If an area is changed, the brightness of the changed area is controlled (S309), and operation stands by until a subsequent display-setting value is input (S311).

Through the process shown in FIG. 3, the operation is controlled, so that only the changed area on the display screen remains at the original brightness while the other areas become dark.

That is, the operation is controlled so that an area on the display, in which the image is changing, remains at the original brightness while the other areas on which the image is not changing become gradually darker.

Therefore, as shown in FIG. 4, the entire screen 10 can be set as a display screen 10′, so that the brightness of a used area 11 remains the same as original and the brightness of an unused area 12 is minimized. In the case in which it is possible to supply electrical power to or control parts (light sources) of the display, the consumption of the electrical power of a battery installed in the mobile terminal can be minimized by controlling the unused area 12 to be powered off.

The display brightness control method of the invention can be carried out using one or more (which are mutually-organized with each other) selected from among a common application program, a system driver of a video card (graphic card), an operation system, firmware of the display, and the like.

For example, in the case in which it is possible to supply electrical power to or control parts (light sources) of the display, as shown in FIG. 5, only a partial area of the entire screen 10 is set to be a display screen 10′. The area, which is not set as the display screen 10′ is powered off from the battery, so that the brightness of the used area 11′ of the display screen 10′ remains as original and the brightness of the unused area 12′ is minimized.

Here, the display screen 10′ can be set from the entire screen 10 by some methods, which set the display screen by changing a resolution, a size, or the like. Of course, it can also be set by a variety of methods upon request from a person having ordinary skill in the art.

Through the above-described processes, the invention controls the brightness of the display according to the areas following a change in the program window, the mouse pointer, the touch pointer, the screen, which are executed by the operating system.

It is apparent that although the present invention has been described in relation to the certain exemplary embodiments thereof, the invention can embrace a variety of variations, changes, and equivalents, and modifications and equivalents to those embodiments can occur with no doubts. Therefore, the foregoing description is in no event to limit the scope of the invention, which shall be defined by the claims appended hereto.

### INDUSTRIAL APPLICABILITY

According to the present invention, it is possible to reduce the consumption of a battery, which is used in the display, and increase the lifetime of the display by dividing the screen output areas of the display into the used area and the unused area so that the used area is output at the original level of brightness and the unused area is controlled to have the minimized level of brightness or is powered off.

In particular, industrial applicability is excellent over a variety of display fields, such as an LCD, an OLED, a PDP, since the power consumption of the battery is reduced through the individual control of the used are of the display.

1. A display brightness control method comprising:
comparing a display-setting value, which is input by user operation, with a setting value, which is set in advance to a display;
if a changed setting value is present, reflecting the changed setting value to the display;
determining whether or not the display-setting value is present;
if the display-setting value is present, reflecting the changed display-setting value to the display; and
after the changed display-setting value is reflected, standing by until a subsequent display-setting value is input.

2. The display brightness control method according to claim 1, wherein a used area on the display is selected by a user, the selected used area remains at original brightness, and an unused area is controlled at a minimum level of brightness or a level of brightness corresponding to a set value, which is designated by the user.

3. The display brightness control method according to claim 2, wherein, when light sources of the display are controlled individually, the brightness of the display is controlled by separately controlling power sources supplied to the light sources of the display.

4. The display brightness control method according to claim 1, wherein, when program windows are being displayed on the display, a program window area, which is being used, remains at a predetermined level of brightness and a remaining area is controlled to be dark.

5. The display brightness control method according to claim 1, wherein, whether or not to change a screen on the display is detected in response to the user operation, a changed area remains at a predetermined level of brightness, and a remaining area is controlled to be dark.

6. The display brightness control method according to claim 1, wherein a partial area of an entire screen of the display is set as a display screen, and if a used area on the set display screen is selected by a user, the selected used area remains at an original level of brightness and an unused area is controlled at a minimum level of brightness or a level of brightness corresponding to a set value, which is designated by the user.

7. The display brightness control method according to claim 6, wherein the display screen is set from the entire screen of the display by changing a resolution or a size.

8. The display brightness control method according to claim 1, wherein the display-setting value includes at least one selected from the group consisting of a brightness-setting value, a minimum value of each area, and an area-setting value of the display, the brightness-setting value including at least one selected from the group consisting of setting values about contrast, brightness, and brightness of each area of the display.

9. The display brightness control method according to claim 2, wherein the display-setting value includes at least one selected from the group consisting of a brightness-setting value, a minimum value of each area, and an area-setting value of the display, the brightness-setting value including at least one selected from the group consisting of setting values about contrast, brightness, and brightness of each area of the display.

10. The display brightness control method according to claim 3, wherein the display-setting value includes at least one selected from the group consisting of a brightness-setting value, a minimum value of each area, and an area-setting value of the display, the brightness-setting value including at least one selected from the group consisting of setting values about contrast, brightness, and brightness of each area of the display.

11. The display brightness control method according to claim 4, wherein the display-setting value includes at least one selected from the group consisting of a brightness-setting value, a minimum value of each area, and an area-setting value of the display, the brightness-setting value including at least one selected from the group consisting of setting values about contrast, brightness, and brightness of each area of the display.

12. The display brightness control method according to claim 5, wherein the display-setting value includes at least one selected from the group consisting of a brightness-setting value, a minimum value of each area, and an area-setting value of the display, the brightness-setting value including at least one selected from the group consisting of setting values about contrast, brightness, and brightness of each area of the display.

13. The display brightness control method according to claim 6, wherein the display-setting value includes at least one selected from the group consisting of a brightness-setting value, a minimum value of each area, and an area-setting value of the display, the brightness-setting value including at least one selected from the group consisting of setting values about contrast, brightness, and brightness of each area of the display.

14. The display brightness control method according to claim 7, wherein the display-setting value includes at least one selected from the group consisting of a brightness-setting value, a minimum value of each area, and an area-setting value of the display, the brightness-setting value including at least one selected from the group consisting of setting values about contrast, brightness, and brightness of each area of the display.
